(19) United States
(12) Patent Application Publication
(10) Pub. No.: US 2016/0137028 A1
(43) Pub. Date: May 19, 2016

(54) INTELLIGENT CLIMATE CONTROL SYSTEM FOR A MOTOR VEHICLE

(71) Applicant: FORD GLOBAL TECHNOLOGIES, LLC, Dearborn, MI (US)

(72) Inventors: William Christopher Trego, Berkley, MI (US); Andrew Eugene Burt, Milford, MI (US)

(21) Appl. No.: 14/547,678

(22) Filed: Nov. 19, 2014

(51) Int. Cl. B60H 1/00

(52) U.S. Cl. CPC B60H 1/00742; B60H 1/00028; B60H 1/00757; B60H 1/00871

(57) ABSTRACT

An intelligent climate control system includes presence sensors for detecting the presence of individuals in the seats of the vehicle. Further, the system includes vents for directing conditioned air toward the detected individuals. Vent control modules control the direction of airflow from the vents in response to control signals from a primary controller.

### TECHNICAL FIELD

This document relates generally to the motor vehicle field and, more particularly, to an intelligent climate control system for a motor vehicle.

### BACKGROUND

To date, automation of climate control systems for motor vehicles has been very limited. It largely consists of separate thermostat settings for the driver and passenger sides of the vehicle. Current state of the art systems simply do not provide or incorporate any ability to control the states of the individual vents. This is necessary if an automated climate control system is to operate at high efficiency and maximize passenger comfort. This document relates to a true intelligent climate control system that allows complete control of the amplitude and the direction of airflow through the various vents of the vehicle to optimize the performance of the climate control system under substantially any operating conditions.

### SUMMARY

In accordance with the purposes and benefits described herein, an intelligent climate control system is provided for a motor vehicle. That intelligent climate control system comprises a first presence sensor, a second presence sensor, a first vent, a second vent, a first vent control module, a second vent control module and a primary controller. The first presence sensor detects the presence of a first individual in a first seating position in the motor vehicle. The second presence sensor detects the presence of a second individual in a second seating position in the motor vehicle.

The first vent directs conditioned air toward the first individual in the first seating position while the second vent directs conditioned air toward the second individual in the second seating position. The first vent control module controls the direction of airflow through the first vent. The second vent control module controls the direction of airflow through the second vent. The primary controller is responsive to the first and second presence sensors and controls the first and second vent control modules.

In one possible embodiment, the first and second presence sensors are cameras. In one possible embodiment, the first vent control module includes a first vent angle driver and a first vent position driver. Further the second vent control module includes a second vent angle driver and a second vent position driver.

In one possible embodiment, the intelligent climate control system further includes a humidity sensor and a temperature sensor that are connected to the primary controller. In one possible embodiment, the climate control system includes an air distribution valve control module for controlling distribution of conditioned air between the different ducts leading to the vents. In one possible embodiment, the various ducts are selected from a group consisting of a windshield, dashboard right, dashboard center, dashboard left, floor right, floor left, floor rear and combinations thereof.

In one possible embodiment, the climate control system includes a voice processor whereby the intelligent climate control system is responsive to voice commands.

In one possible embodiment, the climate control system includes a first backlight in the first vent and a second backlight in the second vent.

In accordance with an additional aspect, a vent control module is provided. The vent control module comprises a vent, a vent angle driver, a vent position driver and a controller. The controller controls the vent angle driver and the vent position driver whereby the direction of airflow is adjusted and controlled at the vent. In one possible embodiment, the vent includes a bezel and a plurality of air direction vanes carried on the bezel. The vent position driver rotates the bezel and the plurality of air direction vanes carried on the bezel about a first axis A₁. Further, each of the plurality of air direction vanes are pivotally adjusted about a second axis A₂ wherein the second axis A₂ is substantially perpendicular to the first axis A₁. Further the vent may include a backlight behind the plurality of air direction vanes.

In accordance with yet another aspect, a method of controlling the flow of conditioned air from a vent in a motor vehicle is provided. That method may be broadly described as comprising the steps of sensing presence of an individual in a car seating position and controlling, by computing device, amplitude and direction of airflow from the vent onto the individual based upon sensor data.

More specifically, the method may include monitoring the individual in the car seat with a camera and controlling, by the computing device, the amplitude and direction of airflow onto the individual based upon data from the camera.

In one possible embodiment, the method may further include monitoring temperature and humidity of the air inside the vehicle and controlling, by the computing device, the amplitude and direction of airflow based upon data from the temperature and humidity sensors. Further, the method may include providing the computing device with facial recognition capability and learning preferred airflow amplitude and direction settings for a particular individual. Still further the method may include the step of recognizing the particular individual when present in the car seat and controlling, by the computing device, the amplitude and direction of airflow in accordance with the preferred settings learned for that individual.

In the following description, there is shown and described several preferred embodiments of the intelligent climate control system. As it should be realized, the system is capable of other, different embodiments and its several details are capable of modification in various, obvious aspects all without departing from the intelligent climate control system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the intelligent climate control system and together with the description serve to explain certain principles thereof. In the drawing figures:

FIG. 1 is a system block diagram of a first embodiment of the intelligent climate control system.

FIG. 2 is a system block diagram of a second embodiment of the intelligent climate control system.

FIG. 3 is a block diagram of a controller for the system.

FIG. 4 is a block diagram of the body control module of the second embodiment illustrated in FIG. 2.

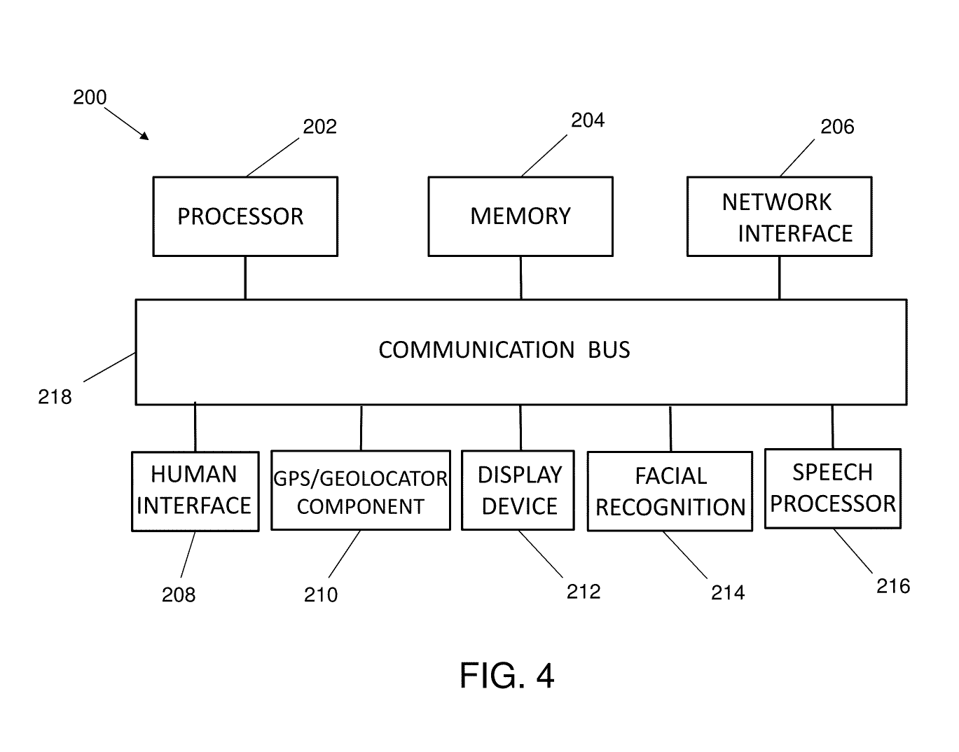

FIG. 5 is a block diagram of various use cases for an intelligent climate control system relying upon camera sensing of individuals occupying vehicle seating positions.

FIG. 6 is a truth table for the operation of the intelligent climate control system for a vehicle incorporating five different, monitored seating positions.

Reference will now be made in detail to the present preferred embodiments of the intelligent climate control system, examples of which are illustrated in the accompanying drawing figures.

### DETAILED DESCRIPTION

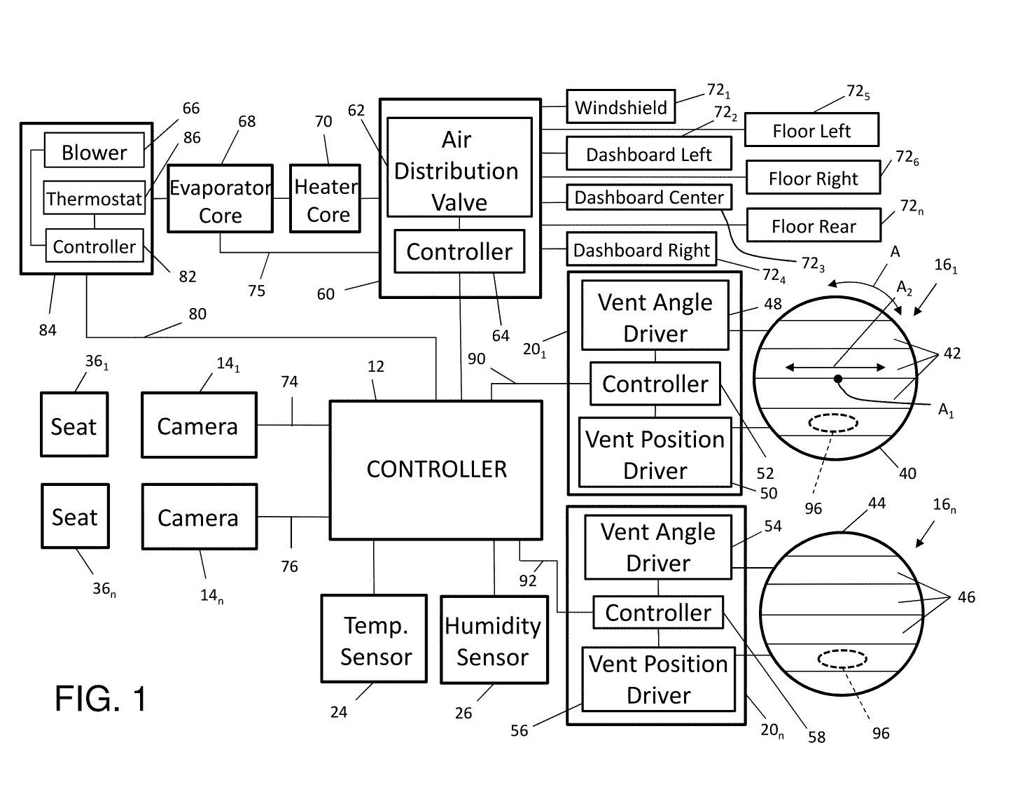

Reference is now made to FIG. 1 schematically illustrating a first embodiment of the intelligent climate control system 10. That system 10 includes a primary controller or electronic control unit (ECU) 12, first and second presence sensors in the form of cameras 14₁, 14ₙ, a first vent 16₁, a second vent 16ₙ, a first vent control module 20₁, a second vent control module 20ₙ, a temperature sensor 24 and a humidity sensor 26.

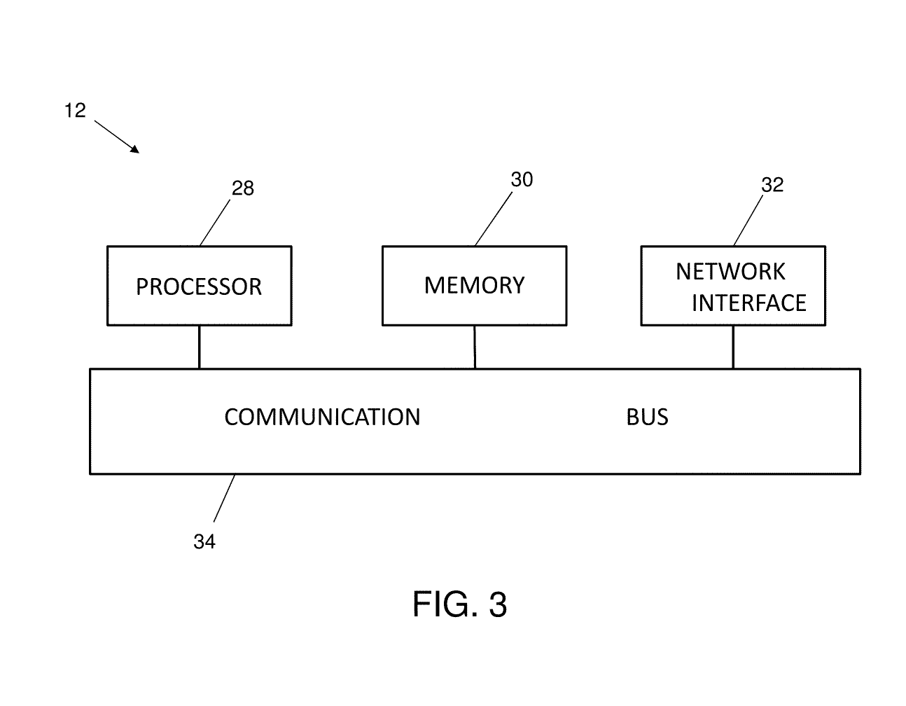

As illustrated in FIG. 3, the controller 12 may comprise one or more processors 28, one or more memories 30, and one or more network interfaces 32. As should be appreciated, all of these components 28, 30, 32 communicate with each other over a communication bus 34.

The presence sensor/camera 14₁ is positioned in the interior of the motor vehicle to detect the presence of a first individual in a first seating position 36₁ in the motor vehicle. Similarly, the second camera/presence sensor 14ₙ is positioned in the interior of the motor vehicle to detect the presence of a second individual in a second seating position 36ₙ. Where the first seating position 36₁ is the driver's seat, such a camera 14₁ may be positioned, for example, in the dashboard, the A-pillar or the headliner with the lens directed toward the seat. While two cameras 14₁, 14ₙ are illustrated in the drawing figures, it should be appreciated that substantially any number of cameras may be provided with one or more monitoring each seat position within the vehicle.

The first vent 16₁ includes a bezel 40 that carries a plurality of air direction vanes 42. Similarly, the second vent 16ₙ includes a bezel 44 carrying a second plurality of air direction vanes 46. The first vent control module 20₁ includes a vent angle driver 48, a vent position driver 50 and a controller 52 in the form of an ECU. The controller 52 may include a structure similar to that illustrated in FIG. 3.

The controller 52 controls the direction of airflow through the first vent 16₁. More specifically, the controller 52 controls the operation of the vent angle driver 48 and the vent position driver 50. The vent position driver 50 rotates the bezel 40 in the direction of action arrow A about a first axis A₁ that extends perpendicular to the plane of the drawing figure. The vent angle driver 48 functions to pivot each of the plurality of air direction vanes 42 about a second axis A₂ wherein the second axis A₂ is substantially perpendicular to the first axis A₁ (note the single axis A₂ illustrated in the drawing figure for the middle vane of the first vent 16). Working together, the vent position driver 50 and vent angle driver 48 allow the airflow through the vent 16₁ to be directed in substantially any direction toward the occupant or passenger whose presence has been detected by the camera 14₁ in the first seating position 36₁.

The second vent control module 20ₙ includes a vent angle driver 54, a vent position driver 56 and a controller 58 that function like the vent angle driver 48, the vent position driver 50 and the controller 52 except the second vent control module controls the direction of airflow from the second vent 16ₙ onto an individual in the second seating position 36ₙ. While two vents 16₁, 16ₙ are illustrated in the drawing figure it should be appreciated that the system 10 may incorporate any number of vents desired to direct airflow to the various passengers occupying the various seating positions 36₁-36ₙ of the vehicle.

More specifically, the vent position drivers 50, 56 and vent angle drivers 48, 54 may each comprise a motor such as a smart motor, a stepper motor or the like. The bezels 40, 44 may each includes a fixed gear drive rack that is driven by the drivers 50, 56 through an appropriate transmission to allow precise angular adjustment. Similarly, the vent angle drivers 48, 54 may drive the vanes 42, 46 through a combined transmission and linkage system.

As further illustrated in FIG. 1, the climate control system 10 also includes an air distribution module 60 which includes an air distribution valve 62 and a controller 64. Further, the system 10 includes a blower 66. The blower 66 draws fresh exterior air and/or recirculated interior air from the cabin of the motor vehicle and then forces that air through the evaporator core 68 where that air is cooled and dehumidified. That air is then directed through the heater core 70 where heat exchange with the engine coolant heats and conditions the air for delivery through the air distribution valve 62 to one or more of the selected ducts leading to, a series of vents 16₁-16ₙ located at, for example, the windshield 72₁, dashboard left 72₂, dashboard center 72₃, dashboard right 72₄, floor left 72₅, floor right 72₆ and floor rear 72ₙ of the vehicle. As should be appreciated, each such duct 72₁-72ₙ may end at a vent such as the vents 16₁-16ₙ described above with their own cooperating control modules 20₁-20ₙ. In summer, the conditioned air from the evaporator core 68 may travel along the bypass line 75 around the heater core to the air distribution valve 62 and then on to the selected ducts 72₁-72ₙ. In order to provide desired cooling.

Operation of the climate control system 10 illustrated in FIG. 1 will now be described in detail. After the vehicle is started, the presence sensor/cameras 14₁, 14ₙ sense the presence of an individual in each of the car seats seating positions 36₁-36ₙ. For purposes of this presentation the cameras 14₁, 14ₙ detect an individual in each seating positions 36₁-36ₙ. The images from the cameras 14₁, 14ₙ are sent along the signal lines 74, 76 to the controller 12 which processes the image data. The controller 12 also receives data from the various sensors in the vehicle including, for example, the temperature sensor 24 and humidity sensor 26 that sense, respectively, the temperature and humidity of the air inside the passenger compartment of the vehicle. Of course, it should be appreciated that other sensors can be provided including, but not limited to, ambient temperature and humidity sensors located on the vehicle exterior to the passenger compartment and temperature and humidity sensors for detecting the temperature and humidity of the conditioned air being provided through the vents 16₁-16ₙ.

Based upon the data provided by the cameras 14₁-14ₙ and sensors 24, 26 the controller 12 then controls the amplitude and direction of airflow from the various vents 16₁-16ₙ onto the individuals in the seating positions 36₁-36ₙ. More specifically, the controller 12 sends a control signal along the signal line 78 to the air distribution valve controller 64 to control distribution of conditioned air to the various ducts 72₁-72ₙ leading to the vents 16₁-16ₙ. Further, the controller 12 sends a signal through the signal line 80 to the controller 82 of the climate control module 84 directing that controller to make appropriate adjustments to the thermostat 86 and blower 66 so that the appropriate amount or amplitude of conditioned air at the desired temperature is delivered through the vents 16₁-16ₙ onto the individuals in the seating positions 36₁-36ₙ. Here it should be appreciated that the controller 12 continuously monitors the data received from the cameras 14₁-14ₙ and the sensors 24, 26 to maximize the comfort of the individuals.

Toward this end, the controller 12 may also adjust the direction of airflow from the vents 16, 18 to provide the conditioned airflow at the most effective angle/direction for the comfort of the individuals in the seating positions 36₁-36ₙ. More specifically, the controller 12 sends a control signal through the signal lines 90, 92 to the respective controllers 52, 58 of the vent control modules 20₁-20ₙ. The controllers 52, 58 respond by controlling the operation of the respective vent angle drivers 48, 54 and vent position drivers 50, 56 to adjust the operational orientation of the vents 16₁-16ₙ respectively. Accordingly, controller 52 adjusts the bezel 40 and vanes 42 of the vent 16₁ into a position that provides the most efficient and effective direction of airflow onto the individual sitting in the seating position 36₁. A similar adjustment is made by the controller 58 to the bezel 44 and vanes 46 of the second vent 16ₙ so that the conditioned air is more efficiently and effectively directed toward the individual sitting in the seating position 36ₙ. Here it should be noted that the position of the individual in either seat may be continuously monitored by the cameras 14₁ or 14ₙ and the direction of airflow from the vents 16₁-16ₙ may be continuously adjusted depending upon any change in position in the seat.

Should the driver drop off his passenger so that the second seat 36ₙ is now unoccupied, the presence sensor/camera 14ₙ will detect the absence of an individual in that seat. In response, the controller 12 will send a signal along control line 78 to the air distribution controller 64 which in turn, will direct the air distribution valve 62 to shut off airflow leading to the duct 72₄ that feeds conditioned air to the vent 16ₙ. This serves to maximize the efficiency of the system 10 which directs all output upon and for the comfort of the individuals whose presence in the vehicle is detected.

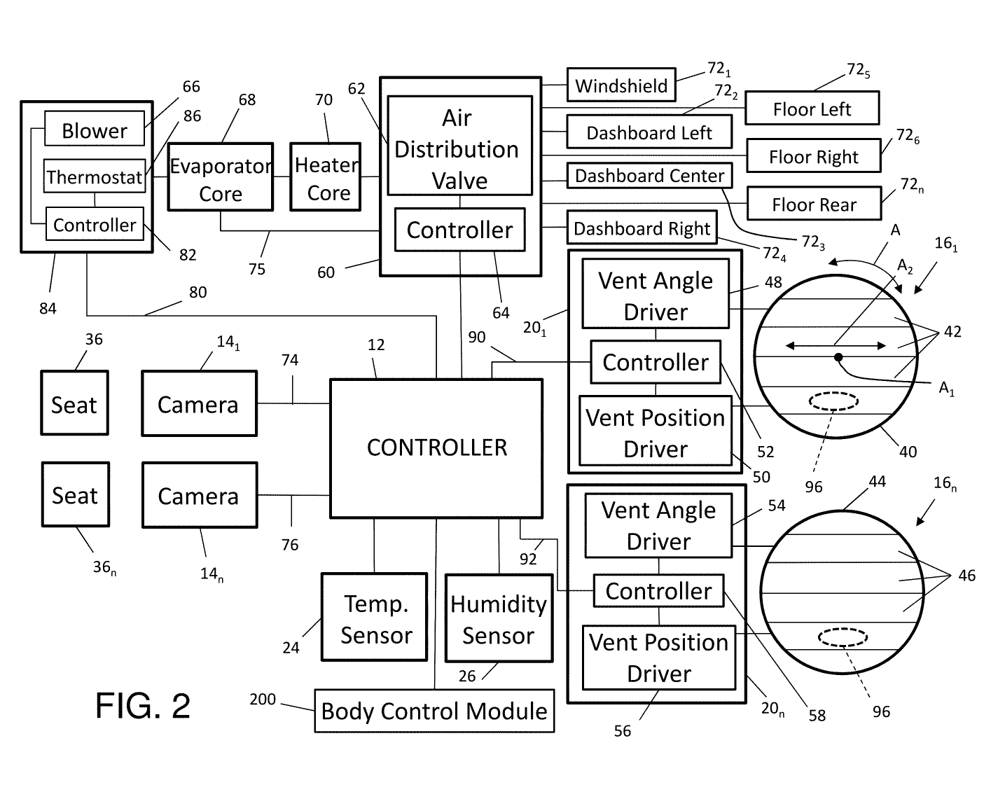

Reference is now made to FIG. 2 illustrating an alternative embodiment of intelligent climate control system 100. In this embodiment, the controller 12 is connected to the body control module or BCM 200. All other components of the second embodiment correspond to those of the first embodiment illustrated in FIG. 1 and include corresponding reference numbers.

The BCM 200 may comprise a computing device having one or more processors 202, one or more memories 204, one or more network interfaces 206, a human interface 208, a GPS/geolocator component 210, a display device such as a multifunction display with touchscreen capability 212, a facial recognition component 214 and a speech processor 216 that all communicate with each other over a communication bus 218. The BCM 200 performs a number of interior body electrically based functions including, for example, interior locking, remote key entry, interior light, exterior light, windshield wiper control and the like. In some embodiments the BCM 200 may also function to control entertainment functions (e.g. radio, CD player and communication such as telephone and internet communication over a wireless network). In some embodiments the BCM 200 is connected by a communication bus (not shown) to other control modules that provide one or more of these additional functions.

Advantageously, the speech processor 216 of the BCM 200 will allow for voice command control of the intelligent climate control system 10. This allows the operator to request system adjustments at any time. Further, where the presence sensors 14₁-14ₙ are cameras, the facial images of the seat occupants may be processed and compared to “known individuals” in the facial recognition component 214. Over time, the system 10 learns the preferred climate control settings for known individuals and stores those in the memory 204. Upon recognizing their presence in the seating positions 36₁-36ₙ through operation of the facial recognition component 214, the system 10 can then adjust the temperature, amplitude and angle/direction of the conditioned air discharged from the vents 16₁-16ₙ in accordance with their learned/known preferences thus maximizing passenger comfort and satisfaction. Of course, at any time a user may switch the system 10 to manual control if desired for any reason. Automatic control is then again available with a simple flip of a switch or voice command.

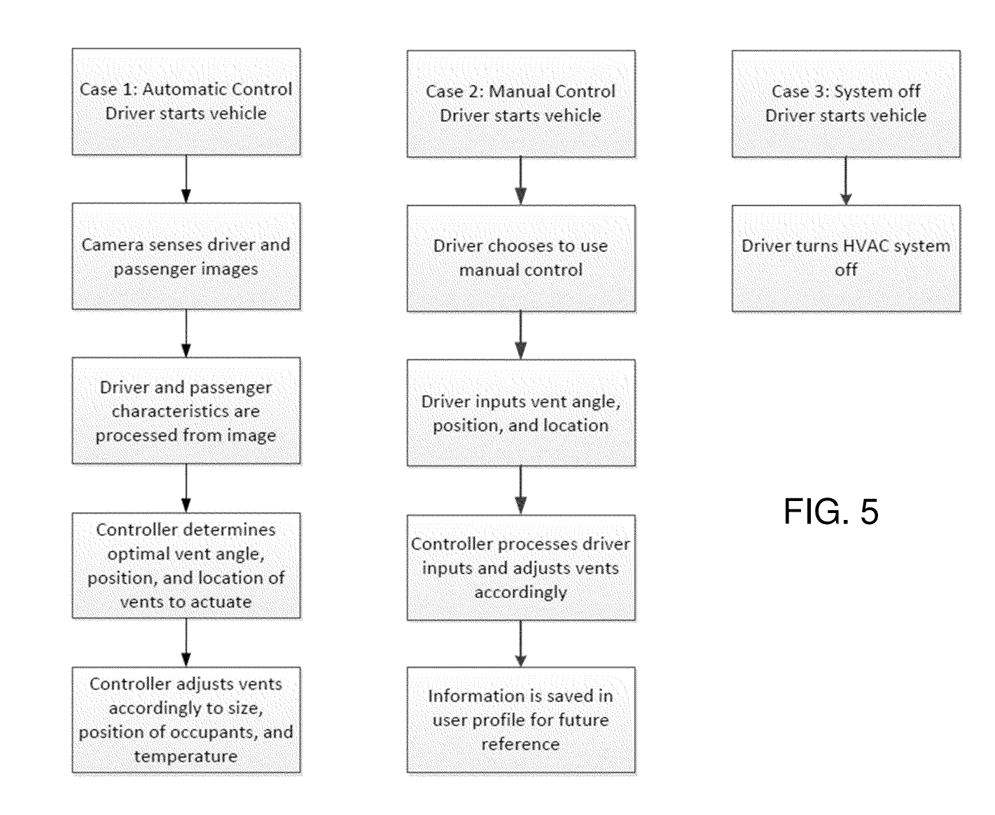

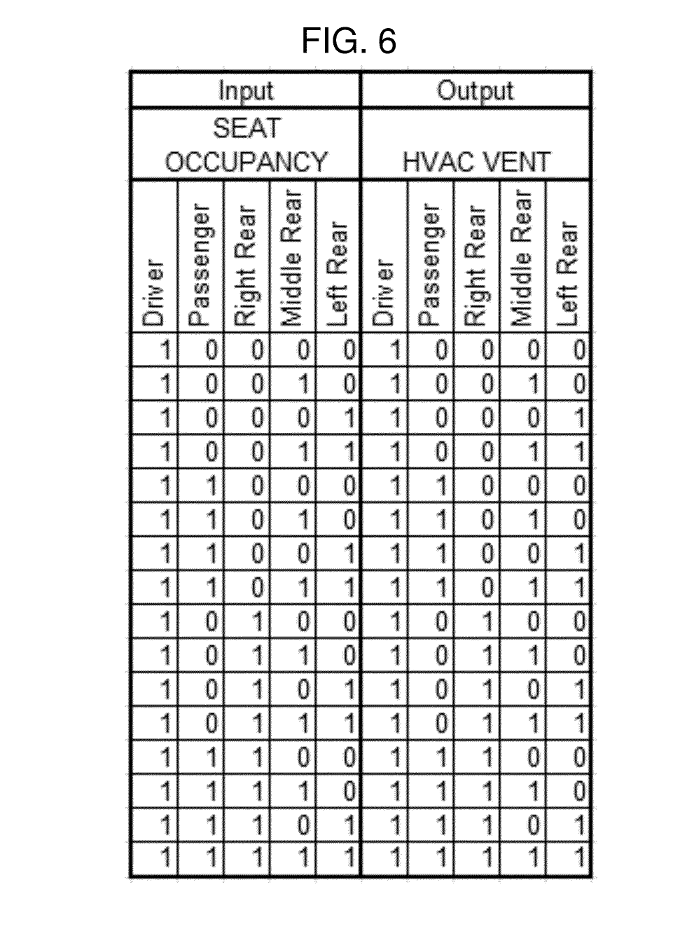

In an effort to further illustrate the intelligent climate control system 10, use cases involving camera presence sensing are illustrated in FIG. 5. In addition a truth table system 10 with camera sensing is illustrated in FIG. 6 for a vehicle with a five passenger seating arrangement.

The foregoing has been presented for purposes of illustration and description. It is not intended to be exhaustive or to limit the embodiments to the precise form disclosed. Obvious modifications and variations are possible in light of the above teachings. For example, in addition to cameras 14₁-14ₙ directed on each seating position 36₁-36ₙ the system 10 may also include a camera directed on the windshield to monitor for windshield fogging. If fogging is detected, the controller 12 may send a control signal along the signal line 78 to the air distribution controller 64 to adjust the air distribution valve 62 and direct more air to the windshield duct 72₁ to clear the fog from the windshield. Further, each vent 16₁-16ₙ may include a backlight 96 in the duct 72₁-72ₙ immediately behind the vent vanes 42, 46. This allows an operator to more easily access the vent vanes 42, 46 in the dark of the night when one desires to manually adjust a vent. Still further, in one possible embodiment the controller 12 may include the speech processor 216 and facial recognition component 214 for voice command and facial recognition capabilities dedicated to the operation of the climate control system. An actuator (not shown) may be provided to turn the back light 96 off and on if desired. All such modifications and variations are within the scope of the appended claims when interpreted in accordance with the breadth to which they are fairly, legally and equitably entitled.

What is claimed:

1. An intelligent climate control system for a motor vehicle, comprising:
a first presence sensor for detecting presence of a first individual in a first seating position in the motor vehicle;
a second presence sensor for detecting presence of a second individual in a second seating position in the motor vehicle;
a first vent for directing conditioned air toward said first individual in said first seating position;
a second vent for directing conditioned air toward said second individual in said second seating position;
a first vent control module for controlling direction of air flow through said first vent;
a second vent control module for controlling direction of air flow through said second vent;
a primary controller that is responsive to said first and second presence sensors and controls said first and second vent control modules.

2. The climate control system of claim 1, wherein said first and second presence sensors are cameras.

3. The climate control system of claim 1, wherein said first vent control module includes a first vent angle driver and a first vent position driver.

4. The climate control system of claim 3, wherein said second vent control module includes a second vent angle driver and a second vent position driver.

5. The climate control system of claim 4, further including a humidity sensor and a temperature sensor connected to said primary controller.

6. The climate control system of claim 5, further including an air distribution valve control module for controlling distribution of conditioned air between different ducts leading to the vents.

7. The climate control system of claim 6, wherein said ducts are selected from a group consisting of windshield, dashboard right, dashboard center, dashboard left, floor right, floor left, floor rear and combinations thereof.

8. The climate control system of claim 7, further including a voice processor whereby said intelligent climate control system is responsive to voice commands.

9. The climate control system of claim 8, further including a first back light for said first vent and a second back light for said second vent.

10. The climate control system of claim 1, further including a first back light for said first vent and a second back light for said second vent.

11. A vent control module, comprising:
a vent;
a vent angle driver;
a vent position driver;
a controller for controlling said vent angle driver and said vent position driver whereby direction of air flow through said vent is controlled.

12. The vent control module of claim 11, wherein said vent includes a bezel and a plurality of air direction vanes carried on said bezel.

13. The vent control module of claim 12, wherein said vent position driver rotates said bezel and said plurality of air direction vanes carried on said bezel about a first axis A₁.

14. The vent control module of claim 13, wherein each of said plurality of air direction vanes are pivoted by the vent angle driver about a second axis A₂ wherein said second axis A₂ is substantially perpendicular to said first axis A₁.

15. The vent control module of claim 14, wherein said vent further includes a backlight behind said plurality of air direction vanes.

16. A method of controlling flow of conditioned air from a vent in a motor vehicle comprising:
sensing presence of an individual in a car seating position; and
controlling, by computing device, amplitude and direction of airflow from the vent onto said individual based upon sensor data.

17. The method of claim 16, including monitoring the individual in said car seating position with a camera and controlling, by said computing device, the amplitude and direction of airflow onto the individual based upon data from said camera.

18. The method of claim 17, further including monitoring temperature and humidity of air inside said vehicle and controlling, by said computing device, the amplitude and direction of airflow based upon data from temperature and humidity sensors.

19. The method of claim 18, including providing said computing device with facial recognition capability and learning preferred airflow amplitude and direction settings for a particular individual.

20. The method of claim 19, including recognizing said particular individual when present in said car seating position and controlling, by said computing device, said amplitude and direction of airflow in accordance with said learned preferred settings.
